(19) United States
(12) Patent Application Publication
(10) Pub. No.: US 2014/0338832 A1
(43) Pub. Date: Nov. 20, 2014

(54) METHOD FOR PRODUCING SILICON FOAM USING DISSIMILAR MATERIALS

(71) Applicant: DONGSUNG SILICON CO., LTD., Gimpo-si (KR)

(72) Inventors: Bo Hwan KIM, Gimpo-si (KR); II Hwan Kim, Incheon (KR)

(21) Appl. No.: 13/913,442

(22) Filed: Jun. 9, 2013

(30) Foreign Application Priority Data
May 16, 2013 (KR) 10-2013-0056033

(51) Int. Cl. B32B 37/14; B32B 37/12; B32B 38/08

(52) U.S. Cl. CPC B32B 37/14; B32B 38/08; B32B 37/1284
USPC 156/280

(57) ABSTRACT

A method for producing a silicon foam using dissimilar materials is disclosed. The method includes partially melting one side of a polyurethane foam using a torch to give the one side adhesiveness, attaching a non-woven fabric to the one side of the polyurethane foam having the adhesiveness, pressing a composite foam of the polyurethane foam and the non-woven fabric using a pressure roller to easily bond them, producing a breathable composite foam having dissimilar materials of the polyurethane foam and the non-woven fabric, impregnating the composite foam having the dissimilar materials with a silicon solution, pressing the composite foam using a pressure roller to control an amount of the silicon solution impregnating the composite foam, and hot-air drying the composite foam while the composite foam passes through a dryer.

### CROSS-REFERENCE TO RELATED APPLICATION

This application claims priority to and the benefit of Korean Patent Application No. 2013-0056033, filed on May 16, 2013, the disclosure of which is incorporated herein by reference in its entirety.

### BACKGROUND

1. Field of the Invention

The present invention relates to a method of producing a silicon foam using dissimilar materials, and more particularly, to a method of producing a silicon foam using dissimilar materials having good material properties, such as breathability, heat-resistance, cold-resistance, durability, water repellency, tensile strength, and tearing strength, by producing a breathable silicon foam through impregnation of a composite foam of dissimilar materials of a non-woven fabric and a polyurethane foam with a silicon solution.

2. Discussion of Related Art

As is known, silicon rubber is a kind of synthetic rubber and has a main chain formed from silicon-oxygen bonds, whereas general synthetic rubber has a main chain formed from carbon-carbon bonds.

In typical silicon rubber, the organic group R bonded to a Si atom consists of a methyl group. Dimethyl silicon rubber is produced through ring-opening polymerization of ring-shaped dimethyl siloxane, which is generated using dimethyldichlorosilane as a raw material through a reaction, such as hydrolysis, condensation, and the like, using a base or an acid as a catalyst. An organic peroxide is generally used in vulcanization of the silicon rubber. Physical properties of vulcanizate are remarkably improved by adding fine silica powder (silicon dioxide) as a reinforcing filler in processing.

The best feature of the silicon rubber is that the silicon rubber can be used across a wide temperature range due to extremely outstanding heat-resistance and cold-resistance. Further, the silicon rubber has been widely used in industrial supplies, such as a heat resistant wire cover, a heat resistant oil seal, an O-ring (a kind of packing), various rolls, and the like, due to outstanding water resistance, ozone resistance, corona resistance, weather resistance, and electrical insulation.

Since the silicon rubber has low vivo toxicity, the silicon rubber has been widely used in a bottle cap for medicine, various medial rubber tubes, a hose for a water purifier, a conveyer belt and roll for food manufacturing, packing for some kinds of coffee pots and jars, and the like.

However, since molded products of the silicon rubber are relatively high-priced and maintain an air-tight internal cell structure, the silicon rubber is difficult to apply in fields requiring heat resistance and breathability.

To address these problems, a process of additionally applying a silicon solution on one side of a breathable material, performing high-density treatment on the one side to have high silicon solution density, and shaving the one side for the high-density treatment is disclosed in Korean Laid-open Patent Application No. 10-2010-0103494, entitled “Method for producing silicon foam having breathable structure”, filed on Sep. 27, 2010.

However, since the technology performs the high-density treatment on the one side and performs low-density treatment on the other side, the process is complicated, and the silicon solution is largely consumed.

### SUMMARY OF THE INVENTION

The present invention is directed to a method for producing a silicon foam using dissimilar materials, which can simplify a process and considerably reduce production costs by reducing the number of impregnation with a silicon solution without shaving of one side for the impregnation with the silicon solution.

The present invention is directed to a method for producing a silicon foam using dissimilar materials, which can significantly improve tearing strength, heat resistance, and breathability.

According to an aspect of the present invention, there is provided a method for producing a silicon foam using dissimilar materials, including: partially melting one side of a polyurethane foam using a torch to give the one side adhesiveness; attaching a non-woven fabric to the one side of the polyurethane foam having the adhesiveness; pressing a composite foam of the polyurethane foam and the non-woven fabric using a pressure roller to easily bond them; producing a breathable composite foam having dissimilar materials of the polyurethane foam and the non-woven fabric; impregnating the composite foam having the dissimilar materials with a silicon solution; pressing the composite foam using a pressure roller to control an amount of the silicon solution impregnating the composite foam; and hot-air drying the composite foam while the composite foam passes through a dryer.

According to another aspect of the present invention, there is provided a method for producing a silicon foam using dissimilar materials, including: applying an adhesive to one side of a polyurethane foam; attaching a non-woven fabric to the one side of the polyurethane foam applied with the adhesive; pressing a composite foam of the polyurethane foam and the non-woven fabric using a pressure roller to easily bond them; producing a breathable composite foam having dissimilar materials of the polyurethane foam and the non-woven fabric; impregnating the composite foam having the dissimilar materials with a silicon solution; pressing the composite foam using a pressure roller to control an amount of the silicon solution impregnating the composite foam; and hot-air drying the composite foam while the composite foam passes through a dryer.

The silicon solution may be produced by mixing siloxane of 60 to 90 wt % and an organic solvent of 10 to 40 wt %, and stirring the mixed siloxane and the organic solvent for 5 to 30 minutes to uniformly mix them.

An organic solvent may be additionally added to control viscosity of the silicon solution.

The adhesive may include one selected from the group consisting of acryl, silicon, and polyurethane.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic illustration of a process of producing a composite foam in a method of producing a silicon foam using dissimilar materials; and

FIG. 2 is a schematic illustration of a process of producing a silicon foam using a composite foam produced in FIG. 1.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a method of producing a silicon foam using dissimilar materials according to the present invention will be described in detail with reference to accompanying drawings.

A method of producing a silicon foam using dissimilar materials according to the present invention can be divided into a process of producing dissimilar materials, and a process of impregnating the dissimilar materials with a silicon solution.

The process of producing dissimilar materials involves producing a silicon foam having a composite structure consisting of a polyester non-woven fabric and a polyurethane material.

The purpose of producing the silicon foam having a composite structure consisting of dissimilar materials is to produce a breathable silicon foam having good material properties arising from the mutually complimentary properties of the polyurethane foam and the polyester non-woven fabric.

Since the polyurethane foam by itself has poor tearing strength, heat resistance, cold resistance, and breathability, the silicon foam produced by impregnating the polyurethane foam with a silicon solution is not suitable to be used in products. However, since a surface of the polyurethane foam is not rough, a shaving process for smoothing the surface of the polyurethane foam after impregnation with the silicon solution is not necessary.

On the other hand, the polyester non-woven fabric has good tearing strength, heat resistance, and breathability. However, since the polyester non-woven fabric has an open cell structure, a process of impregnating the polyester non-woven fabric with a silicon solution has to be performed several times. In particular, the non-woven fabric is disadvantageous in that, since the fabric has a rough surface, after the non-woven fabric is impregnated with the silicon solution and hardened, the non-woven fabric should be subjected to a shaving process and impregnated with the silicon solution again.

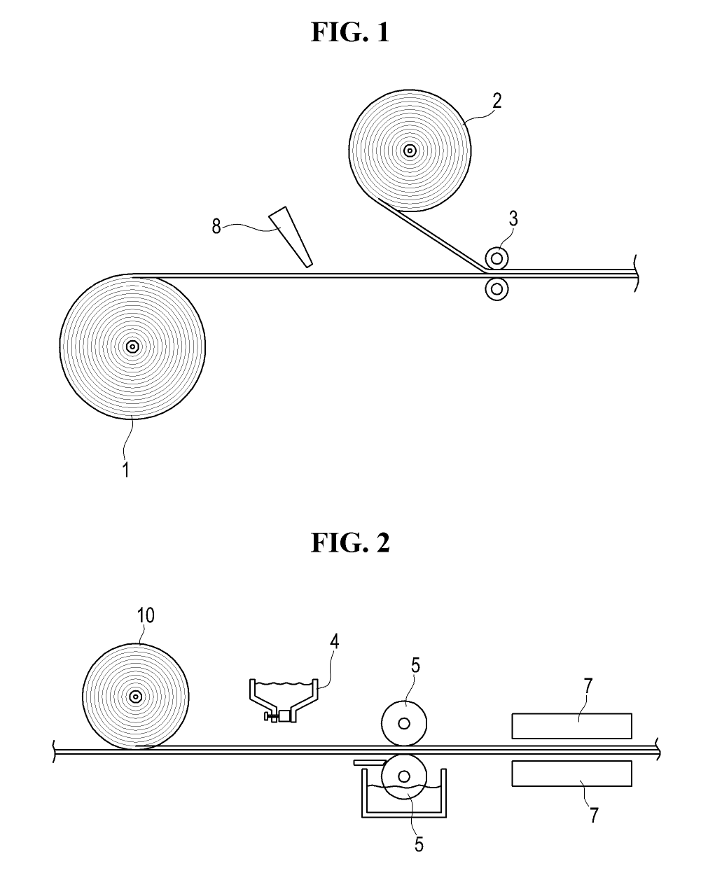

As illustrated in FIG. 1, the process of producing dissimilar materials according to the present invention includes a process of partially melting one side of a polyurethane foam 1 using a torch 8 to give the one side adhesiveness.

A heating temperature of the torch 8 may be in the range of 600 to 700° C. The adhesiveness of the one side is reduced when the heating temperature is lower than 600° C., and the polyurethane foam 1 is difficult to use in products due to overheating when the heating temperature is higher than 700° C.

A non-woven fabric 2 is attached to the one side of the polyurethane foam 1 having the adhesiveness.

A composite foam of the polyurethane foam 1 and the non-woven fabric 2 is pressed by a pressure roller 3 to be bonded well.

Through the above-described process, a breathable composite foam 10 (see FIG. 2) having dissimilar materials of the polyurethane foam and the non-woven fabric may be produced.

In the process of producing dissimilar materials, some other process of applying an adhesive to the polyurethane foam 1 may be used, besides the process of heating the polyurethane foam 1 using the touch 8 to give the polyurethane foam 1 adhesiveness. For example, an adhesive may be applied to the one side of the polyurethane foam 1 and then the polyester non-woven fabric may be bonded to the one side.

At this time, the adhesive may include acryl, silicon, or polyurethane. A thickness of the adhesive may be in a range of 10 to 100 μm. Adhesion is reduced and bonding is not easy when the thickness is smaller than 10 μm, and breathability is not good when the thickness is larger than 100 μm.

The composite foam 10 having the dissimilar materials produced through the above-described process is impregnated with a silicon solution. The process of impregnation with the silicon solution is to allow the liquid silicon solution to infiltrate into a surface and inside of the composite foam.

As illustrated in FIG. 2, the silicon solution may be applied to the composite foam 10 from a tank 4 located over the composite foam 10, and the silicon solution may be applied to the composite foam 10 through a roller 5 located below the composite foam 10.

The silicon solution may be produced by mixing siloxane of 60 to 90 wt % and an organic solvent of 10 to 40 wt %, and stirring the siloxane and the organic solvent for 5 to 30 minutes to uniformly mix them. An organic solvent may be additionally added to control viscosity of the silicon solution. A silicon solution whose viscosity is controlled to 2000 to 800000 cps at 25° C. may be used.

The composite foam 10 may be impregnated with the silicon solution for 5 seconds to 1 minute so that the silicon solution sufficiently infiltrates the composite foam 10.

The composite foam 10 may be pressed using a pressure roller to control an amount of the silicon solution impregnating the composite foam 10.

Finally, to produce a breathable silicon foam, the composite foam is hot-air dried while the composite foam passes through a dryer 7. At this time, a hot-air dry period of time is about 5 to 30 minutes, and a hot-air dry temperature is in a range of 100 to 200° C. However, the hot-air dry period of time and the hot-air dry temperature may be controlled according to an amount of the infiltrated silicon solution.

### Example

One side of polyurethane foam was heated at a temperature of 650° C. using the torch 8 to give the one side adhesiveness, and a polyester non-woven fabric was attached to the one side to produce a composite foam of dissimilar materials. A silicon solution was produced by mixing dimethyl polysiloxane of 70 wt %, xylene of 25 wt %, and tourmaline of 5 wt %. The composite foam was impregnated for 1 minute by immersing the composite foam in 10 l of the produced silicon solution. The composite foam impregnated with the silicon solution was supplied to a pressure roller and hot-air dried to produce a final silicon foam.

### Comparative Example

A non-woven fabric was impregnated with a silicon solution for 1 minute twice. The non-woven fabric impregnated with the silicon solution was supplied to a pressure roller and hot-air dried to produce a final silicon foam.

Tensile strength and elongation of the silicon foams produced according to Example and Comparative Example are listed in Table 1.

TABLE 1

| | Example | Comparative Example |
|---|---|---|
| Tensile Strength (Kgf/cm²) | 5.5-5.8 | 3.7-3.9 |
| Elongation (%) | 450-480 | 340-360 |

As seen from Table 1, the present invention obtains better tensile strength and elongation than Comparative Example, which may represent existing products.

As described above, a breathable silicon foam having dissimilar materials according to the present invention can have good breathability, have a stable and flexible expanded cell, and have physical properties that neither non-woven fabric nor polyurethane have by impregnating a composite material (non-woven fabric and polyurethane foam) with a silicon solution, in addition to breathability, heat resistance, cold resistance, durability, water repellency, tensile strength, and tearing strength.

According to the present invention, shaving for impregnation with a silicon solution, which is performed on one side of a composite foam, is not necessary, and the number of impregnation with the silicon solution can be reduced. Therefore, the process can be simplified and production costs can be significantly reduced.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A method for producing a silicon foam using dissimilar materials, the method comprising:
partially melting one side of a polyurethane foam using a torch to give the one side adhesiveness;
attaching a non-woven fabric to the one side of the polyurethane foam having the adhesiveness;
pressing a composite foam of the polyurethane foam and the non-woven fabric using a pressure roller to easily bond them;
producing a breathable composite foam having dissimilar materials of the polyurethane foam and the non-woven fabric;
impregnating the composite foam having the dissimilar materials with a silicon solution;
pressing the composite foam using a pressure roller to control an amount of the silicon solution impregnating the composite foam; and
hot-air drying the composite foam while the composite foam passes through a dryer.

2. The method of claim 1, wherein the silicon solution is produced by mixing siloxane of 60 to 90 wt % and an organic solvent of 10 to 40 wt %, and stirring the mixed siloxane and the organic solvent for 5 to 30 minutes to uniformly mix them.

3. The method of claim 1, wherein an organic solvent is additionally added to control viscosity of the silicon solution.

4. A method for producing a silicon foam using dissimilar materials, the method comprising:
applying an adhesive to one side of a polyurethane foam;
attaching a non-woven fabric to the one side of the polyurethane foam applied with the adhesive;
pressing a composite foam of the polyurethane foam and the non-woven fabric using a pressure roller to easily bond them;
producing a breathable composite foam having dissimilar materials of the polyurethane foam and the non-woven fabric;
impregnating the composite foam having the dissimilar materials with a silicon solution;
pressing the composite foam using a pressure roller to control an amount of the silicon solution impregnating the composite foam; and
hot-air drying the composite foam while the composite passes through a dryer.

5. The method of claim 4, wherein the silicon solution is produced by mixing siloxane of 60 to 90 wt % and an organic solvent of 10 to 40 wt %, and stirring the mixed siloxane and the organic solvent for 5 to 30 minutes to uniformly mix them.

6. The method of claim 4, wherein an organic solvent is additionally added to control viscosity of the silicon solution.

7. The method of claim 4, wherein the adhesive includes one selected from the group consisting of acryl, silicon, and polyurethane.
